(19) United States
(12) Patent Application Publication
(10) Pub. No.: US 2008/0067849 A1
(43) Pub. Date: Mar. 20, 2008

(54) Apparatus and Method for Moving Persons Between a Sitting and a Standing Position

(76) Inventor: Tristan Frencken, Drunen (NL)

Correspondence Address: HOFFMANN & BARON, LLP, 6900 JERICHO TURNPIKE, SYOSSET, NY, 11791, US

(21) Appl. No.: 11/629,771

(22) PCT Filed: Jun. 15, 2005
(86) PCT No.: PCT/NL05/00436

§ 371 Date: May 15, 2007

(30) Foreign Application Priority Data
Jun. 15, 2004 (NL) 1026420

(51) Int. Cl. B60N 2/02; A47C 1/00

(52) U.S. Cl. 297/330; 297/337

(57) ABSTRACT

The invention relates to an apparatus for moving persons from a sitting to a standing position and vice versa. The invention also relates to a supporting structure provided with such an apparatus. The invention further relates to a method. for moving person from a sitting to a standing position and vice versa.

The invention relates to an apparatus for moving persons from a sitting to a standing position and vice versa. The invention also relates to a supporting structure provided with such an apparatus. The invention further relates to a method for moving persons from a sitting to a standing position and vice versa.

For disabled persons, it is often difficult to move from a sitting position to a standing position and vice versa. As a rule, such disabled persons, such as for instance the elderly or persons recovering from a leg fracture, need help from another person for moving from a sitting condition to a standing condition and vice versa. Another person assisting a disabled person during standing up and sitting down is relatively awkward and time-consuming, and furthermore, as a rule, constitutes a relatively great physical effort for this other person while generally, especially the back of the assistant is relatively heavily loaded. As these disabled persons often move around by means of a wheelchair, it also often happens that no assistants are present in the direct vicinity to assist the disabled persons in rising from the wheelchair and hence standing up. In such a situation, the disabled person is to stand up and sit down by himself which, for many of these persons, is hardly possible, if at all, so that relatively simple activities such as posting a letter or phoning in a phone box are often impossible or can only be carried out through relatively great physical effort.

The object of the invention is to provide an apparatus for moving people independently between a sitting position and a standing position.

To that end, the invention provides an apparatus of the type mentioned in the opening paragraph, comprising: a basic structure designed to be borne on a supporting structure, in particular a wheelchair, the basic structure being provided with coupling means for detachably coupling the basic structure to the supporting structure, and a top structure connected to the basic structure, provided with a seat designed for supporting a person, while the mutual orientation between the top structure and the basic structure can be altered such that the person can be moved between a sitting position and a standing position. By attaching the apparatus according to the invention as a separate module to a supporting structure such as for instance a bed, a chair and in particular, a wheelchair, the disabled person no longer needs help from another person in order to move between a sitting position and a standing position. With the aid of the apparatus according to the invention, the person can relatively easily rise by himself and sit down on the respective supporting structure. As a rule, the apparatus will be positioned on a conventional seat or supporting surface of a supporting structure. In order to substantially fix the apparatus relative to the supporting structure, the apparatus is coupled to the supporting structure. Usually, the coupling means are of a conventional nature and can be formed by, for instance, one or several straps, Velcro tape, or in a mechanical manner by means of clamps et cetera.

In a preferred embodiment, the top structure is pivotally connected to the basic structure. As a result, it is relatively easy for a seated person to move in upward (and partly forward) direction in order to stand up. Here, the relative orientation between the supporting structure and the basic structure remains substantially unchanged in order to optimize the efficiency and the effectiveness of the apparatus according to the invention. However, it can also be conceived that a person moves by means of a different sort of change in orientation between the basic structure and the top structure. Here, moving the top structure, for instance upright or not upright in vertical or diagonal direction, respectively, relative to the basic structure can be considered. Such a displacement of the top structure relative to the basic structure can, optionally, be combined with pivoting the top structure relative to the basic structure.

Preferably, the orientation between the top structure and the basic structure can be changed between a first condition, designed for supporting the person in a substantially sitting position, and a second condition, designed for supporting the person in a substantially standing or at least leaning position. More preferably, the apparatus is provided with locking means for locking the relative orientation of the basic structure and the top structure in the first condition and/or the second condition. From a point of view of safety, it may be desirable to lock the apparatus in the first and/or the second condition. Owing to this fixing, the relative orientation between the top structure and the basic structure is substantially fixed, so that undesired collapsing or folding out, that is to say an actual movement of the apparatus from one condition to the other condition, can be prevented or can at least be combated. In particular during temporary positioning such a locking can be desirable, which is beneficial to third parties such as, for instance, children. Only by actively unlocking the locked apparatus the person can change the condition of the apparatus.

In another preferred embodiment, the basic structure and the top structure are coupled to movement means for moving the basic structure and the top structure relative to each other. Here, the movement means can be of quite varied nature and facilitate the change in orientation between the basic structure and the top structure. The positioning of the movement means relative to the basic structure and the top structure can be fairly diverse too. As a rule, the top structure and the basic structure will be mutually pivotally connected, the top structure being pivotable relative to the basic structure, and hence the supporting structure, about a pivot. Here, the movement means can be arranged around or adjacent the pivot. However, it is also conceivable that the movement means be positioned at a distance from the pivot. In a special preferred embodiment, the movement means comprise urging means for urging the top structure apart from the basic structure. As a rule, the urging means will comprise one or several springs in order to exert a permanent or not permanent bias to, on the one side, the basic structure and, on the other side, the top structure. Several types of springs can be used here, among which, for instance, gas springs, compression springs and torsion springs. However, it is also conceivable to have the movement means be formed by several mutually cooperating mechanical components which, further, can be driven by an electric motor. Here, an electric motor that may have been included in an electrically operated (wheel) chair can be used for driving the movement means. It is preferred that the movement means can be activated by the person using the apparatus. In this manner, the person can operate the movement means in an electric, mechanical, pneumatic and/or, optionally, hydraulic manner in order to independently sit down and/or stand up in a facilitated manner.

In yet another preferred embodiment, the apparatus is provided with limiting means for limiting the relative displacement of the basic structure and the top structure. As a result, it is possible to move the top structure relative to the basic structure in a manner ideal for the person, to thus optimize assisting in standing up and sitting down. By limiting the maximum displacement of the top structure relative to the basic structure, the top structure can be prevented from stretching excessively or moving relative to the basic structure, so that unsafe situations in which the person is brought into an unstable position and might even fall, can be prevented.

Preferably, the apparatus is provided with at least one supporting element for stabilizing the person during movement of the person from a sitting to a standing position and vice versa. As a rule, several supporting elements will be used simultaneously for stabilising the person, in particular when moving the person from the sitting to the standing position and vice versa. As a rule, the supporting elements will be formed by handles attached to the basic structure or to the top structure. It is also conceivable to use, in addition to or instead of handles, other types of stabilizing elements such as foot rests for stabilizing the feet of the person, or supporting elements designed for stabilizing, in particular fixing, the knees of the person when the person stands up and sits down.

In a preferred embodiment, the dimensioning, or at least the effective dimensioning of the basic structure can be changed. By adjusting the dimensioning defining the perimeter of the basic structure to the nature, design and dimensioning of the supporting structure, the apparatus can relatively easily be attached to several types of supporting structures. Moreover, the dimensioning of the basic structure can relatively easily be adjusted to the length and the posture of the person. As a result, a universally usable adaptive apparatus can be obtained that can be mounted and dismounted relatively easily.

In another preferred embodiment, the top structure can be moved relative to the basic structure according to a predefined path. Preferably, the design of the path can de geared to the desires of the person. In this manner, when standing up and sitting down, the person can be optimally supported by the apparatus. Here, the design of the path ideal for the person can depend on the length, the posture and the weight of the person. Often, the physical moment of the relative pivotal movement of the top structure and the basic structure is defined by the distance from the movement means to the pivot. By changing the path, as a rule, also the physical moment of the apparatus is changed so that the upward force generated by the movement means can be regulated and can thus be adapted to, for instance, the body weight of the person.

In yet another preferred embodiment, the top structure is provided with a backrest against which the person can lean, in particular in a sitting position, in order to stabilize the person in an additional manner. Here, the backrest can be rigidly coupled to the seat but is preferably pivotally coupled to the seat in order not to form an obstruction when the person stands up. During displacement of the top structure in an upward direction, the backrest is preferably pivoted in a direction away from the top structure so that the person needs not experience any discomfort by the backrest. As a rule, the backrest will then be coupled to the basic structure, so that the aforementioned pivotal movement of the backrest can be realized.

It is preferred that the apparatus is designed so as to be mobile, thereby increasing the handling and usability of the apparatus. The apparatus can then be manufactured from a material with a relatively low specific density so that handling is further improved.

The invention also relates to a supporting structure provided with such an apparatus. Here, the supporting structure is preferably formed by a wheelchair. However, it is also conceivable to use other types of supporting structures, such as for instance a bed, a chair and a couch. The apparatus can then be used in a private context but can also be used in the medical and/or therapeutic sector. In a particular preferred embodiment, the apparatus is detachably coupled to a car seat or to a back seat of a car.

The invention further relates to a method for moving persons from a sitting to a standing position and vice versa with the aid of such an apparatus, comprising the following steps: A) detachably coupling the apparatus to a supporting structure, B) having the seat of the top structure engage the person, and C) moving the top structure relative to the basic structure such that the person is moved from a sitting position to a standing position or vice versa. Preferably, the apparatus is detachably coupled to a wheelchair when step A) is carried out. Further advantages of the method according to the invention have already been described in the foregoing.

The invention will be clarified with reference to non-limitative exemplary embodiments represented in the following Figures. In the Figures:

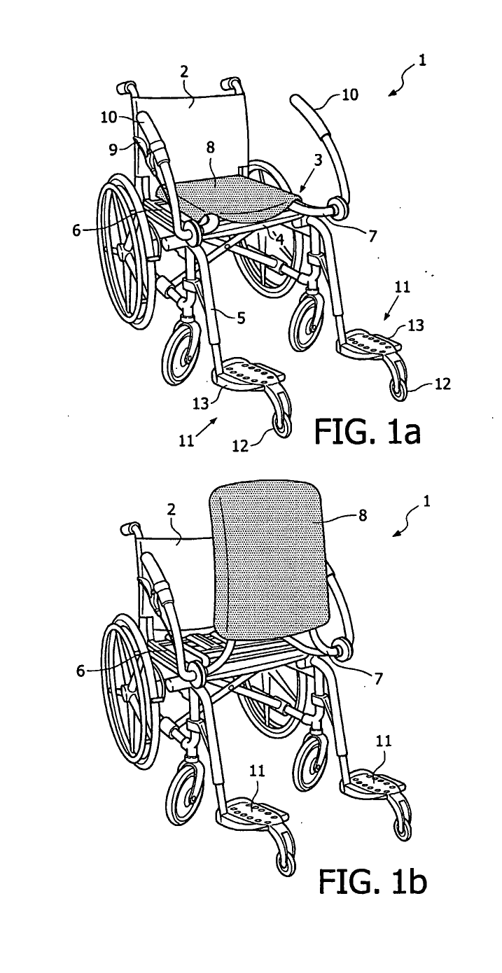

FIG. 1a shows a perspective view to an assembly of a wheelchair and an apparatus according to the invention detachably coupled to the wheelchair, in collapsed condition;

FIG. 1b shows a perspective view to the assembly according to FIG. 1a in a folded-out condition;

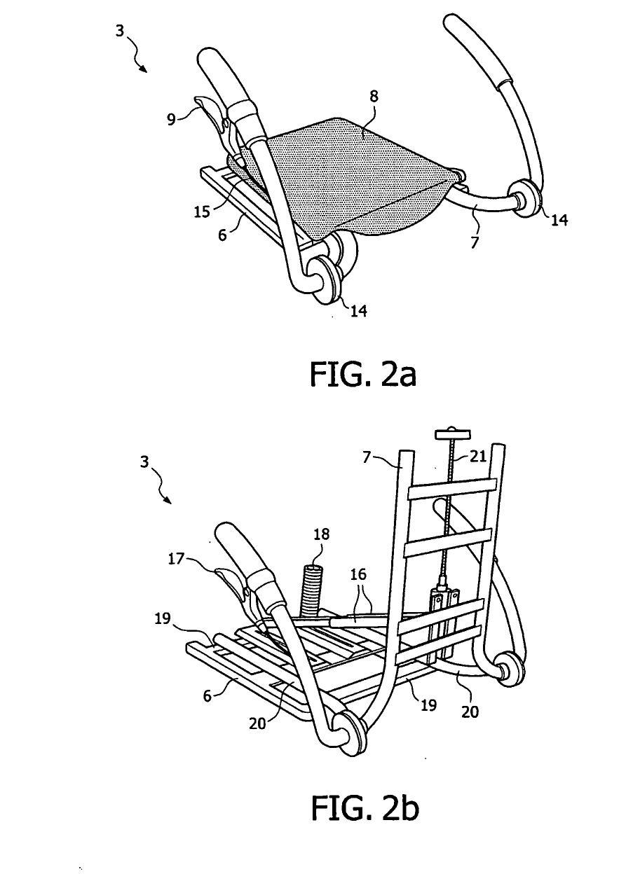

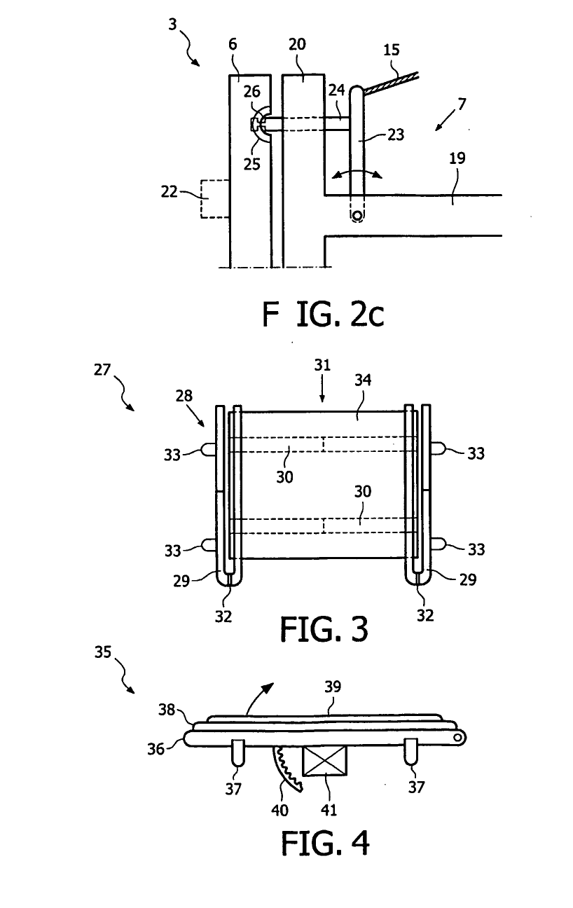

FIG. 2a shows a perspective view to the apparatus according to FIGS. 1a and 1b in a collapsed condition;

FIG. 2b shows a perspective view to a part of the apparatus according to FIG. 2a in a folded-out condition;

FIG. 2c shows a detailed top plan view to the apparatus according to FIG. 2a;

FIG. 3 shows a top plan view to another apparatus according to the invention;

FIG. 4 shows a side view to yet another apparatus according to the invention;

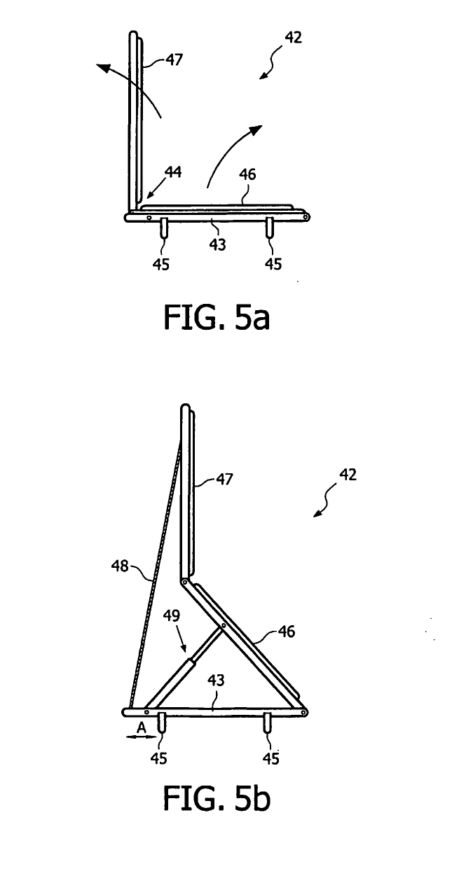

FIG. 5a shows a schematic side view to an alternative apparatus according to the invention in a collapsed condition; and

FIG. 5b shows a schematic side view to the apparatus according to FIG. 5a in a stretched-out condition.

FIG. 1a shows a perspective view to an assembly 1 of a wheelchair 2 and an apparatus 3 according to the invention detachably coupled to the wheelchair 2 in collapsed condition. Here, the apparatus 3 is substantially positioned on a seat 4 of the wheelchair 2 and is detachably coupled to a frame 5 of the wheelchair 2. The apparatus 3 comprises a basic structure 6 provided with coupling means (presently not represented) for coupling the basic structure 6 to the wheelchair 2. The apparatus 3 also comprises a top structure 7 pivotally connected to the basic structure 6, and provided with a substantially rigid seat 8 for a person which seat is preferably manufactured from polyester. In the condition shown, the top structure 7 is designed to be pivoted in an upward, forward direction away from the basic structure 6 and the wheel chair 2, while the pivot is positioned in front of the (front longitudinal edge of the) seat 8. As a result, when pivoting upwards, the front longitudinal edge of the seat rises so that a better contact with the supported person is maintained. The collapsed condition shown of the apparatus 3 is locked by means of locking means (see FIG. 2c) in order to prevent the top structure 7 from undesirably pivoting relative to the basic structure 6. Here, the locking means can be unlocked via a handle 9. The handle 9 is arranged on one of two handgrips 10 positioned laterally relative to the seat 4. The handgrips 10 are rigidly connected to the basic structure 6 and are designed for stabilizing the person during standing up from and, optionally sitting down in, the wheelchair 2. The handgrips 10 extend adjacent the seat; while, furthermore, they can be attached adjacent the pivot. With them, each time, a good support can be obtained. Further stabilizing measures for the person during movement between a sitting position and a standing position are provided by feet supports 11 forming part of the apparatus 3. Here, the feet supports 11 are each provided with a supporting wheel 12. Preferably, each supporting wheel 12 is blocked when the person stands up from (and again when the person sits down in) the wheelchair 2. The feet supports 11 are detachably connected to conventional feet supports 13 forming part of the wheelchair 2. Between the basic structure 6 and the top structure 7, several springs are provided (see FIG. 2b), designed for urging the top structure 7 and the basic structure 6 apart. As already mentioned, such a displacement is presently avoided by locking the collapsed condition represented. After unlocking, the seat 4 will be propelled in upward and forward direction, owing to which standing up from the wheelchair 3 is significantly simplified for the person. The force exerted by the springs is then preferably such that, on the one side, the person can be moved in a controlled manner to a standing orientation while, on the other side, the force can be conquered in a relatively simple manner when subsequently, the person sits down again in the wheelchair 3. In this manner, the person can move, completely autonomously and independently in a relatively simple and user-friendly manner between a sitting position and a standing position. FIG. 1b shows a perspective view to the assembly 1 according to FIG. 1a in a folded out condition. In this Figure, it is clearly visualized that the top structure 7 has been moved in a vertical, or at least diagonal direction relative to the basic structure 6 and the wheelchair 3, so that the upper body of the person engaging the seat 8 of the top structure 7 is urged in an upward direction and the person has thus been moved from a sitting position to a standing position, or at least a position leaning against the seat 8. Here, the feet of the person can remain bearing on the feet rests 11. Optionally, the knees of the person can also be secured to the wheelchair 2 by means of straps (not represented) designed to that end.

FIG. 2a shows a perspective view to the apparatus 3 according to FIGS. 1a and 1b in a collapsed condition. Presently, it is clearly shown that the top structure 7 and the seat 8 are pivotally connected to the basic structure 6 via two hinge points 14 provided in front of the seat 8. In FIG. 2a it is also visualized that the handle 9 is coupled to a cable 15, which cable 15, on an opposite side, is coupled to the locking means (see FIG. 2c). FIG. 2b shows a perspective view to a part of the apparatus 3 according to FIG. 2a in folded-out condition. In order to clarify the view to the apparatus 3, in FIG. 2b the seat 8 is not represented. As shown in FIG. 2b, the top structure 7 and the basic structure 6 are also mutually coupled by means of gas springs 16 orientated parallel to each other, for urging the top structure 7 and the basic structure 6 apart. Additionally, the basic structure 6 is provided with a compression spring 17 which only engages the top structure 7 when the apparatus 3 is in collapsed condition. The main function of the compression spring 17 is initiating the top structure to be urged apart from the basic structure 6. The basic structure 6 is also provided with an elastic sheath 18 so that, in a controlled an user-friendly manner, the apparatus 3 can be completely collapsed while the top structure 7 and the basic structure 6 are prevented from knocking into each other in a relatively hard manner. It is also shown in FIG. 2b that the dimensioning of the basic structure 6 is adjustable. To that end, the basic structure 6 is provided with several telescopic crossbars 19 and longitudinal bars 20. By means of a pivot 21 connected to the top structure 7 and provided with external thread, the position of engagement of the gas springs to the top structure 7, and hence the physical moment of the apparatus 3, can be regulated which can be beneficial to the user-friendliness. FIG. 2c shows a detailed top plan view to the apparatus 3 according to FIG. 2a. In the collapsed condition shown, the basic structure 6 and the top structure 7 are located in substantially the same plane. Here, the coupling means 22 connected to the basic structure 6 extend in a direction away from the top structure 7. As shown, the cable 15 connected to the handle 17 is connected to a pivotal push element 23 connected to a crossbar 19 such that the pivotal push element 23 is urged in a direction towards the basic structure 6. The push element 23 is coupled to a locking pin 24 which is partly received in a receiving space provided in a longitudinal bar 20 while a free end, at least a narrowed part of the end of the locking pin 24 is coupled to a guiding lip 25 provided with a feed-through opening 26 for the locking pin 24. Only by moving the top structure 7 slightly downwards, for instance by sitting down on the seat 8, the locking pin 24 can be taken from the lip 25 so that the apparatus 3 is unlocked.

FIG. 3 shows a top plan view to a different apparatus 27 according to the invention. The apparatus 27 comprises a bottom frame 28 provided with two telescopically adjustable longitudinal bars 29 and two telescopically adjustable cross bars 30. The bottom frame 28 is pivotally coupled to a top frame 31, while in the hinge points 32 of the bottom frame 28 and the top frame 31 a torsion spring (not represented) is provided for urging the top frame apart from the bottom frame 28 to thus, in conformity with the apparatus 3 shown in FIGS. 1 and 2, assist a person in standing up and sitting down. The bottom frame is provided with several hook-shaped elements 33 for detachably coupling the apparatus to a supporting structure, such as for instance a (wheel)chair or a bed. The top frame 31 is provided with a seat 34 for a person. FIG. 4 shows a side view of yet another apparatus 35 according to the invention. The apparatus 35 is provided with a lower frame part 36 comprising coupling means 37 for coupling the apparatus 35 to a supporting structure. The lower frame part 36 is pivotally coupled to an upper frame part 38 provided with a seat 39. The upper frame part 37 is also provided with a projecting toothed arm 40 designed for cooperation with an electric motor 41 connected to the lower frame part 36 for changing the mutual orientation between the bottom frame part 36 and the top frame part 37 in an electromechanical manner in order to assist a person in standing up and sitting down.

FIG. 5a shows a schematic side view to an alternative apparatus 42 according to the invention in collapsed condition. The apparatus 42 comprises a support 43 and a top part 44 pivotally connected to the support 43. The support 43 is provided with universal coupling means 45 for universal coupling of the apparatus 42 to a supporting structure (not represented). The top part comprises a seat 46 and a backrest 47 pivotally connected to the seat 46. FIG. 5b shows a schematic side view to the apparatus 42 according to FIG. 5a in a stretched-out condition. In FIG. 5b it is clearly represented that the relative orientation between the seat 46 and the backrest 47 changes during the change in relative orientation between the seat 46 and the support 43. To that end, the backrest 47 is connected to the support 43 by means of a guy wire 48. The change in relative orientation between the support 43 and the top part 44 can be effected by means of (de)activating a pneumatic cylinder 49 provided between the support 43 and the top part 44. In order to regulate the upward force of the cylinder 49 and to gear it to, for instance, the body weight of the person, the point of engagement of the cylinder 49 on the support 43 is adjustable (see arrow A).

It will be clear that the invention is not limited to the exemplary embodiments represented and described here, but that within the framework of the accompanying claims countless variants are possible which will be obvious to the person skilled in this field of technology. For instance, with each of the variants of an apparatus 3, 27, 35, 42 according to the invention, this can also be used instead of an original seat of a support such as a bed, chair, couch or wheelchair. All this is then preferably designed such that the apparatus 3, 27, 35, 42 and the original seat are and remain exchangeable. However, the apparatus according to the invention can also form an integral part of the supporting structure such as a wheelchair, bed, couch or chair.

1. An apparatus for moving persons from a sitting to a standing position and vice versa, comprising:
a basic structure designed to be borne on a supporting structure, in particular a wheelchair, the basic structure being provided with coupling means for detachably coupling the basic structure to the supporting structure, and
a top structure connected to the basic structure, provided with a seat designed for supporting a person,
wherein the relative orientation between the top structure and the basic structure can be changed such that the person can be moved between a sitting position and a standing position.

2. An apparatus according to claim 1, characterized in that the top structure is pivotally connected to the basic structure.

3. An apparatus according to claim 1, characterized in that the orientation between the top structure and the basic structure can be changed between a first condition designed for supporting the person in a substantially sitting position and a second condition designed for supporting the person in a substantially standing position.

4. An apparatus according to claim 3, characterized in that the apparatus is provided with locking means for locking the relative orientation of the basic structure and the top structure in the first condition and/or the second condition.

5. An apparatus according to claim 1, characterized in that the basic structure and the top structure are coupled to movement means for moving the basic structure relative to the top structure.

6. An apparatus according to claim 5, characterized in that the movement means comprise urging means for urging the top structure apart from the basic structure.

7. An apparatus according to claim 6, characterized in that the urging means comprise at least one spring.

8. An apparatus according to claim 5, characterized in that the movement means are coupled to an electric motor.

9. An apparatus according to claim 5, characterized in that the movement means can be activated.

10. An apparatus according to claim 1, characterized in that the apparatus is provided with limiting means for limiting the relative displacement of the basic structure and the top structure.

11. An apparatus according to claim 1, characterized in that the apparatus is provided with at least one supporting element for stabilizing the person when the person is moved from a sitting to a standing position and vice versa.

12. An apparatus according to claim 11, characterized in that the supporting element is formed by a handle or a foot support.

13. An apparatus according to claim 1, characterized in that the dimensioning of the basic structure can be changed.

14. An apparatus according to claim 1, characterized in that the top structure can be moved relative to the basic structure according to a predefined path.

15. An apparatus according to claim 14, characterized in that the path to be traversed can be preset.

16. An apparatus according to claim 1, characterized in that the top structure is provided with a backrest.

17. An apparatus according to claim 16, characterized in that the seat and the backrest are mutually pivotally coupled.

18. An apparatus according to claim 1, characterized in that the apparatus is designed to be mobile.

19. A supporting structure provided with an apparatus according to claim 1.

20. A supporting structure according to claim 19, characterized in that the supporting structure is formed by a wheelchair.

21. A method for moving persons from a sitting to a standing position and vice versa, with the aid of an apparatus according to claim 1, comprising the following steps:
A) detachably coupling the apparatus to a supporting structure,
B) having the seat of the top structure engage the person, and
C) moving the top structure relative to the basic structure such that the person is moved from a sitting position to a standing position and vice versa.

22. A method according to claim 21, characterized in that the apparatus is detachably coupled to a wheelchair when step A) is carried out.
